(19) United States
(12) Patent Application Publication
(10) Pub. No.: US 2008/0258476 A1
(43) Pub. Date: Oct. 23, 2008

(54) Security system

(76) Inventor: Robert David Simpson, Rickmansworth (GB)

Correspondence Address: Thomas M. Galgano, Suite 204, 20 W. Park Avenue, Long Beach, NY, 11561, US

(21) Appl. No.: 11/981,372

(22) Filed: Oct. 31, 2007

Related U.S. Application Data
(63) Continuation-in-part of application No. 10/486,995, filed on Feb. 13, 2004, now Pat. No. 7,350,836.

(30) Foreign Application Priority Data
Aug. 17, 2001 (GB) 0120107.8

(51) Int. Cl. E05C 3/02

(52) U.S. Cl. 292/194

(57) ABSTRACT

A security system for constraining the degree to which a closure leaf such as a door may be opened of the type has an inoperative position in which it does not block the opening and closing of the closure leaf, and an operative position in which it does so block the opening of the closure leaf beyond a predetermined constrained degree. The system is selectively activatable for effecting movement between said inoperative and said operative position. The improvement provides for the provision of an electric actuator which includes a motor having a rotatable output shaft, an arm operating in response to movement of the output shaft of the actuator, whereby the actuator drives the arm both into and out of the operative position; and at least a portion of the arm when in the operative position is moved into a position where the arm acts as a barrier to the door leaf being opened beyond a predetermined degree.

### CROSS-REFERENCE TO RELATED APPLICATION

This application is a continuation-in-part of application Ser. No. 10/486,995 filed on Feb. 13, 2004.

### BACKGROUND OF THE INVENTION

The invention relates to security systems and is specifically concerned with a security system for constraining the degree to which a closure leaf may be opened.

### DESCRIPTION OF RELATED ART

Security systems adapted for the purpose just outlined are known generally and several examples of them can be studied in, for example, published PCT Patent Application No WO 00/73609 A1 (RDS Innovations Limited) and the several cited documents brought forward against its claims when it was searched.

Document WO 00/73609 A1 is the closest prior art currently known to the applicant and it acknowledges that the basic principle of the moving arm physically blocking the opening of the door leaf is sound. This principle forms the framework for this current invention and document WO 00/73609 A1 forms the starting point for the present invention.

This document describes and illustrates several differing embodiments of a door security system. Each of these embodiments is complex in nature.

One of these embodiments comprises an arm carried on a chassis which in use is mounted adjacent an edge of the door leaf. The arm comprises a steel plate bent at one end to form a door retaining tab. The displacement of the arm from its inoperative position to its door blocking position is achieved by a spring which releases its potential energy when a solenoid causes a release arm to free the arm. A part from this solenoid, there is also provided a motor to drive the arm from its blocking position to its inoperative position while charging the spring.

There are also no means specified to retain the arm in a particularly advantageous blocking position. In activation the arm swings through approximately 180° and may even impact on the door leaf prior to any required blocking. This particular prior art embodiment presents an over-complicated door blocking system which is incapable of achieving precise door blocking.

Another WO00/73609 A1 embodiment presents a ram-driven (i.e. hydraulic) piston used to pivot a blocking arm. The control of such a system has not been detailed in that application.

Means of achieving such control would therefore be left to the skilled person in the art who would find it particularly difficult to put into practice.

### SUMMARY OF THE INVENTION

This current patent application aims to provide an improved system for restraining the degree to which a door leaf may be opened.

One of the objectives of this invention is to provide a system with a minimum number of components which would enable rapid manufacture at a low cost.

A further objective of this invention is to provide a locking arm which can be precisely controlled.

An additional aim of this invention is to provide a system which can be improved in terms of its ability of preventing forced entry.

A further objective of this invention is to provide a system which can be placed adjacent to the doors edges no matter in what direction the door opens and which may be removed from one position to another by the user of the security system.

Various deterrent and/or identification systems are also speculated in this published WO 00/73609 A1 document. Audible and/or visual alarms, visual image detection means, dye-release and pressure-sensing add-ons are all covered and in general, the document gives a pretty comprehensive overview of what might be done but without concentrating on any specific preferred design, it is therefore another objective of this present invention to propose a particularly advantageous deterrent and/or identification system.

In a broad independent aspect, the invention provides a security system for constraining the degree to which a closure leaf such as a door may be opened of the type having an inoperative position in which it does not block the opening and closing of the closure leaf, and an operative position in which it does so block the opening of the closure leaf beyond a predetermined constrained degree; and means for selectively activating said system for effecting movement between said inoperative and said operative position, the improvement comprising:

an electric actuator comprising a motor having a rotatable output shaft; an arm operating in response to movement of said output shaft of said actuator, whereby said actuator drives said arm both into and out of said operative position; and at least a portion of said arm when in said operative position is moved into a position where said arm acts as a barrier to said door leaf being opened beyond a predetermined degree.

In another broad aspect, the invention provides a security system for constraining the degree to which a door leaf may be opened; the system being selectively activated from an inoperative position in which it does not block the opening and closing of the door leaf, into and out of an operative position in which it does so block the opening of the door leaf beyond a pre-determined constrained degree; the system being characterised in that it comprises:

A chassis adapted for mounting, in use, adjacent an opening edge of the door leaf;

An electric actuator mounted on the chassis;

An arm operating in conjunction with the said actuator that the actuator drives the motion of the said arm without any lost motion mechanism.

This combination of features advantageously simplifies this type of door locking system. It dramatically reduces the number of components necessary to achieve the necessary motion of the arm. This improved version is therefore more cost effective.

A further advantage of this configuration is that the position of the arm is more accurately controlled as the arm operates in conjunction with the actuator so that the actuator drives the motion of the arm.

A subsidiary aspect of the current invention in accordance with its broadest aspect presents a system wherein the actuator drives the rotation of the arm.

Arranging this system so that the actuator drives the rotation of the arm is particularly advantageous because it facilitates the precise angular positioning of the arm.

In an additional aspect of the current invention, the chassis mounting means is of a kind whereby in use the chassis when mounted will be secured primarily to the wall, bulkhead or other basic load-bearing structure surrounding the door rather than being secured primarily to the intermediate door frame or the like.

Securing the chassis primarily to the wall rather than primarily to the intermediate door frame further improves the blocking ability of this system.

In a further subsidiary aspect, the actuator is a motor and the motor operates under direct current to produce a non-step-by-step rotation, when the motor is in use.

In WO00/73609A1 the motors envisaged are stepping motors fed by AC current. It is well known that this type of motor can achieve a rapid rotation, however it also requires relatively complex control functions. The current invention marks a fundamental departure from the whole teaching of this prior document because it stems from the realisation that a short distance, only of travel of the arm (hence a relatively slow swing arc) is all that is actually needed to bring it into blocking engagement with the door leaf edge. The selection of motor in this current invention further contributes to simplifying the elements required to drive the arm. The present configuration may for example employ a low torque 12 volt motor and achieve accurate blocking and sufficiently rapid motion from the inoperable position to the blocking position. Another realisation stemming from this one is that accordingly the arc through which the arm of WO 00/73609 A1 first embodiment swings could be restricted; far from needing to be the best part of 180° as in that embodiment's illustrated teaching (FIG. 3) therein.

In further preferred subsidiary aspects of the invention the following features are apparent:

The arm rotates through no more than approximately 120 degrees when moving from its inoperative position into its door leaf blocking position.

The pivotal arc of movement of the arm from its inoperative position into its blocking position could be as little as 30 degrees and may advantageously lie within the range 30 degrees to 100 degrees.

The arc of movement of the arm from its inoperative position into its blocking position lies preferably within the range 90 degrees to 100 degrees.

As for the scatter-gun approach of listing every conceivable (but already known in themselves individually) alternative add-on, again the present invention rejects this in favour of entirely new thinking. Ideally a security system embodying the invention will incorporate only those features which truly give an inventive combination of utility and comprehensive action.

Any opening—or attempted opening beyond a certain sensed pressure—of the door leaf triggers automatically a dumping from the system of a liquid of the kind made distinctive for example by ultra-violet light and whose characteristics are such that, once a person bearing any of the liquid has been thus identified, the security system from which that specific liquid came can be established beyond reasonable doubt.

In a further subsidiary aspect, the means securing the chassis in use to the surrounding primary load-bearing structure comprise coach bolts or the like which are long enough to pass if necessary through a frame surrounding the door leaf and into the primary load-bearing structure surrounding the door unit as a whole.

Incorporating into the current system the above feature is particularly advantageous because it strengthens the locking ability of the system and therefore reduces the likelihood of forced entry.

In a further subsidiary aspect, the actuator is a motor and the arm movement into and out of its door leaf blocking position is effected solely by the rotation of the motor output shaft with essentially no other arm urging means being deployed.

This particular configuration presents a further improved version of this type of system with minimal components in order to enable simplicity during the function of the system and in its assembly.

In an additional subsidiary aspect, the actuator causes the arm to displace into and out of its blocking position along a line of action which is essentially parallel to the face of the door leaf whilst being spaced therefrom.

This aspect is particularly advantageous because it minimises the required travel distance covered by the arm when it displaces into and out of its blocking position.

In a further subsidiary aspect, the arm operates in conjunction with the actuator so that the arm in its inoperative position does not traverse the axis of the door leaf's adjacent edge.

This latest aspect is particularly advantageous because it enables the system to be placed adjacent to the door leaf irrespective of the door leaf's opening direction.

In another broad independent aspect the invention provides, a security system for a closure leaf such as a door or window comprising a unit which pops into sight when the closure leaf is open and which returns to a retracted position as a leaf is closed, characterised in that said unit incorporates a powered security component which is switched on when the unit is in its popped out position.

This configuration is particularly advantageous because it allows improved security of a door for example without being visible before the door is opened. The system also is particularly advantageous because it allows the door or window to operate in its conventional fashion so that it doesn't affect the conventional use of the door.

In a subsidiary aspect in accordance with the invention's broad independent aspect, said security component is a camera.

In a further subsidiary aspect, said security component is a sprayer.

In a further subsidiary aspect, said unit is located in a cavity of a frame, is hinged on said frame and a bias is provided to cause said unit to pop out of the frame when the closure leaf is open. This is particularly advantageous because it doesn't require external devices since the security system may be fitted within the volume of a conventional frame. It also removes any requirement for complex actuation systems.

In a further subsidiary aspect, said camera operates in conjunction with a wireless transmitter to transmit signals representative of images to a location remote from said unit.

In a further subsidiary aspect, said powered security component is connected to a closure leaf blocker which prevents the door from opening beyond a pre-determined partially opened degree and is activated when excessive pressure is applied on said blocker. This configuration is particularly advantageous as it allows filming and spraying for example to be carried out simultaneously with the control of the angle by which a door is opened.

In another broad independent aspect, the invention provides a security system for constraining the opening of a closure leaf such as a door beyond a pre-determined partially opened degree comprising a chassis; means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; characterised in that means for mounting said chassis incorporate a plurality of predetermined positions for securing said chassis. This configuration is particularly advantageous because it allows the closure leaf to open to varying degrees dependent upon the position of the chassis. It allows a door leaf to be secured in a particularly narrow entrance to a building for example.

In a subsidiary aspect in accordance with the aforementioned broad independent aspect, said means for mounting incorporates one or more rails and said chassis is mounted on said rails in order to be placed in a plurality of pre-determined positions. The configuration is particularly advantageous because it allows the controlled displacement of the chassis.

In another broad independent aspect, the invention provides a security system for constraining the opening of a closure leaf such as a door beyond a pre-determined partially opened degree comprising a chassis; means for mounting said chassis, in use, adjacent an opening of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; and an actuator which drives the motion of said arm; characterised in that said actuator is a rotor which transmits rotation to said arm via a gear.

This configuration is particularly advantageous because it allows the transmission of rotation from the rotor to be driven without any loss motion mechanism.

In another broad independent aspect, the invention provides a security system for constraining the opening of a closure leaf such as a door beyond a pre-determined partially open degree comprising a chassis, means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially open degree; characterised in that said chassis is located at least in part within a hollow portion of a closure leaf frame. This configuration is particularly advantageous because it allows the security system to be primarily enclosed within existing leaf frame dimensions. It also adds protection to the security system since in order to damage the system an intruder would have to breach the leaf frame.

In another broad independent aspect, the invention provides a portable security unit comprising a motion sensor, an alarm and activation means; wherein the motion sensor, the alarm and activation means are each housed by the unit. This configuration is particularly advantageous because it allows the device to be relatively compact in order to be transportable from one monitoring position to another.

In a subsidiary aspect in accordance with the aforementioned broad independent aspect, the invention further comprises means for sounding a message; a bank of messages containing messages in a plurality of languages; a means allowing the user of the unit to select the appropriate language to be used. This configuration is particularly advantageous because it allows a user to employ the portable security unit in a plurality of geographical locations worldwide.

In a further subsidiary aspect, the portable security unit further comprises a transmitter for transmitting a signal representative of activation to an individual located remotely.

In a further subsidiary aspect, the portable security unit further comprises a camera and/or a microphone for collecting sound and/or pictures and/or video operating in conjunction with a transmitter for transmitting a signal representative of sound and/or pictures and/or video collected by said camera and/or microphone.

This allows the user to observe any potential security breach from a distance.

In another broad independent aspect, the invention provides a security system for a closure leaf such as a door or window comprising a unit which pops into sight when the closure leaf is open and which returns to a retracted position as the leaf is closed, characterised in that said unit incorporates a powered security component, which is switched on when the unit is in its popped out position and a linkage member extending between a portion of said security system secured adjacent to said closure leaf and a portion of said security system secured on said closure leaf; wherein when pressure is exerted on said closure leaf beyond a predetermined level a security component is actuated.

In a subsidiary aspect, said security component incorporates a sprayer.

In a subsidiary aspect, said security component incorporates a camera.

In a further subsidiary aspect, said unit is located in a cavity of said closure leaf adjacent portion and a bias is provided to cause said unit to pop out of the frame when the closure leaf is open.

In a further subsidiary aspect, said closure leaf adjacent portion houses a canister for a sprayer, one or more batteries, and an alarm generator.

In a further subsidiary aspect, said closure leaf adjacent portion incorporates means for securing said portion to the frame of the closure leaf and said portion which is secured to the closure leaf incorporates means for securing the portion to the closure leaf and a strike plate for engagement with said unit; whereby when said closure leaf is closed shut the strike plate causes the unit to return to a retracted position and when the closure leaf is opened the strike plate is removed from said unit, whereby said unit is free to pop into sight.

### BRIEF DESCRIPTION SEVERAL VIEWS OF THE DRAWINGS

FIG. 1 shows, in diagrammatic perspective view, a security system embodying the invention mounted in use adjacent the top opening edge of a door leaf.

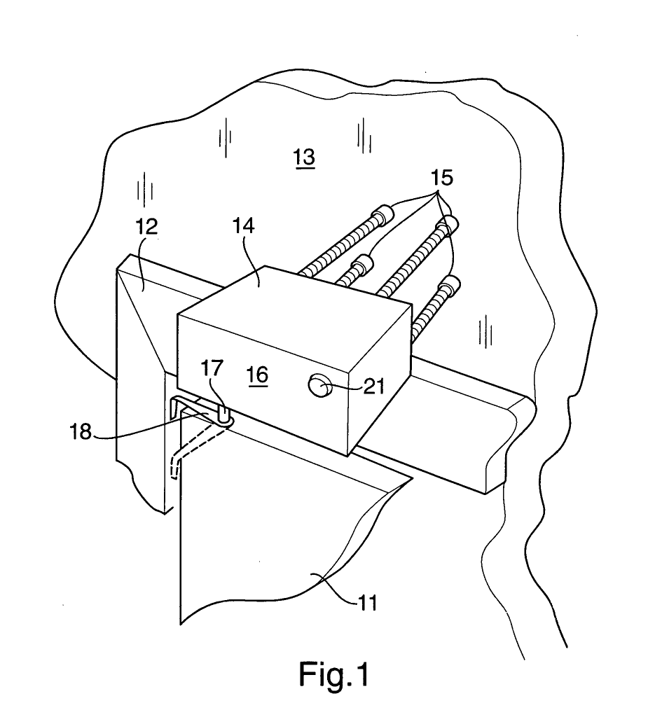

FIG. 2 presents a diagrammatic cross sectional side view of the security system in a further embodiment of the invention.

FIG. 3 shows a diagrammatic cross sectional side view of a further embodiment of the invention.

FIG. 4 shows a view of a security device from beneath in accordance with a further embodiment of the invention.

FIG. 5 shows an end section in perspective view of the embodiment of FIG. 4.

FIG. 6 shows a cross-sectional view through the housing for the embodiment of FIG. 4.

FIG. 7 shows a cross-sectional view through the gear housing for the embodiment of FIG. 4.

FIG. 8 shows a modification to the embodiment of the FIG. 4 in plan view.

FIG. 9 shows a perspective view of an armature, gear housing and motor.

FIG. 10 shows a perspective part cross-sectional view of an armature, gear housing and motor.

FIG. 11 shows a further perspective part cross-sectional view of an armature, gear housing and motor.

FIG. 12 shows a further perspective part cross-sectional view of an armature, gear housing and motor

FIGS. 13A, B and C show respectively a front elevation of a door when a security system is inactive, a front elevation of a door when a security system is active and a front elevation of a security component in perspective view.

FIGS. 14A and 14B show schematic cross-sectional views of a security component in accordance with a further embodiment respectively in the inactive and the active position.

FIG. 15 shows a security device in accordance with a further embodiment of the invention in schematic cross-sectional view where the security device is located within the frame of a closure leaf such as a door.

FIG. 16 shows a further embodiment of the invention in the form of a portable security unit in perspective view.

FIG. 17 show a further embodiment of the security system of FIGS. 6 and 7.

FIG. 18 shows a door security system with a portion secured to the doorframe and a portion secured to the door leaf. The view is a perspective schematic view from the outside.

FIG. 19 shows portions of the security system when the door leaf is opened. The view is a perspective view from the inside.

FIG. 20 shows a further view from the outside as a perspective view with the addition of a potential spray zone.

FIG. 21 shows a perspective schematic view of the portions of a security system when the door leaf is shut.

FIG. 22 shows a view from the inside of the portions of a security system when the door leaf is shut.

### DETAILED DESCRIPTION OF THE INVENTION

The drawing shows schematically the opening edge region of a door leaf 11 conventionally hinged (by means not illustrated) within a similarly conventional frame 12 fixed to surrounding brickwork 13. The brickwork 13 forms the primary load bearing structure into which the door opening is cut.

A chassis 14 is mounted in this instance directly to the brickwork 13 by coach bolts 15 of known kind. These bolts 15 locate the chassis 14 above the top rail of the door frame 12. Although there is no obvious reason why, as long as the bolts 15 are long enough, the chassis 14 could not be mounted so as to sandwich the top rail of the frame 12 between itself and the brickwork 13 with the coach bolts 15 then passing through the top rail before they enter the brickwork in which they are finally embedded, this preferred direct-to-brickwork mounting is far more advantageous as will be apparent later.

The chassis 14 comprises a back plate, from which the coach bolts 15 project as shown, and a removable box-style cover. The cover referenced 16 in the drawing is rectangular in plan and in elevation and may be of conventional formation. The means securing it removably to the coach bolt bearing back plate of the chassis 14 can similarly be selected from known alternatives.

Inside the cover 16 and not shown in the drawings is a conventional 12 volt low torque ungeared electric motor. Its output shaft 17 projects from the underside of the cover 16 and in front of the top rail of the door frame 12 through an appropriate aperture in the cover. Fixed to the extremity of shaft 17 is a T-shaped lightweight metal arm 18 which itself ends in a right-angled tab as shown.

Activation of the motor by any of the intruder-sensitive means canvassed in the previous documents causes the shaft 17 to rotate and to take with it the arm 18 into the broken-line position shown in the drawing.

In that broken-line position the end tab of the arm 18 physically blocks the opening of the door leaf 11 in the direction of arrow A by anything other than a relatively small amount. Unauthorised intruders can therefore be prevented from entering. Resetting the arm 18 to its inoperative illustrated position can be accomplished by known alternatives and, as shown, the arm rotates through only approximately 90 degrees from its inoperative to its operative position.

A proximity detector 21 on the front face of the cover 16 may be linked to a video camera or other conventional equipment for monitoring the presence of people outside the door. But in practical preferred embodiments a communications port from the system will enable not only video cameras surveillance but also linkage to a health alarm loop, a police local warning loop, or other appropriate hook-up and these together with the rest of the system will be fully-digitally controlled.

The proximity detector 21 is shown as part of the chassis box. It may (although not illustrated in this embodiment) be on the outside of the door or building and automatically trigger the movement of the arm from its inoperative position to its blocking position when an individual is detected in the vicinity of the door. In this configuration, the door security system does not require any manual activation, the access being advantageously under automatic control. In this particular configuration, it is also envisaged that the return of the arm to its inoperative position may be achieved manually rather than automatically.

Also incorporated into the system will be a so-called dye dump. This was speculated on but not developed in WO 00/73609 A1. Contrary to the lack of detail therein (the term “dye dump” could cover things which are literally illegal) the invention specifically provides for the use of an ultra-violet identifiable liquid for example one which is of a type known currently under the name SMART WATER (a registered Trade Mark of SMART WATER LIMITED) and which is contained in a suitably incorporated canister within cover 16 and is automatically sprayed onto any unwarranted attempted intruder as or after the door leaf is opened and especially if an attempt is made to force it beyond the blocking presence of the in-use arm 18.

This liquid is dumped by an electronically controlled screw-in valve which activates automatically under preset door-opening conditions (or under predetermined pressure-sensed conditions whether or not the door is actually opened) and is supplied from store in canisters each of which has a different “tag” in that the liquid dispensed from a specific canister can uniquely be identified as having come from that canister.

It is a characteristic of this liquid that it cannot normally be seen but is immediately shown up under for example ultra-violet light. Anyone who has intruded or attempted to intrude past the closed door can thus be identified subsequently, for quite a long period of time before the effect wears off, even if he may not realise it at the time of his offence. Once so identified, the unique “fingerprint” of the particular liquid with which he was coated can be traced immediately back to a canister, located of course in a specific security system installation, and hence tie him beyond reasonable doubt to a recently recorded intrusion attempt on that system.

Mounting the chassis 14 directly onto the hard flat non-yielding brickwork 13 enables the tab of arm 18 to be of optimally minimum length; as the whole chassis/motor/arm unit will not flex unduly in use. Mounting the chassis via the door frame by contrast could permit undue flexing under load and the tab would have to have a safety margin lengthwise to allow for this possibility. The preferred example would be both neater, and less prone to fouling with repeated use, on that basis.

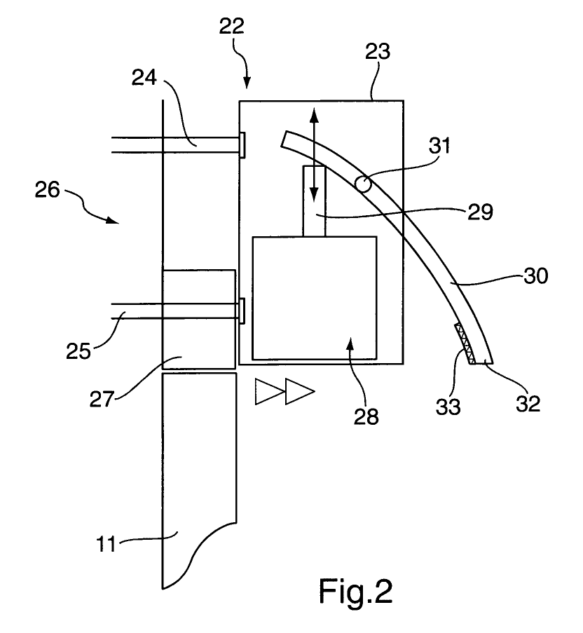

FIG. 2 presents a further embodiment of the present invention, where the door security system is generally referenced at 22. This door security system comprises a chassis 23 which is attached to a wall 26 via four appropriate screw means of which only screw means 24 and 25 are represented in the drawing. Screw means 25 traverses a section of the door frame 27 and extends into wail 26 to ensure that the wall acts as the primary load-bearing structure.

Chassis 23 is essentially boxed shaped and sufficient in size to house a rotor 28.

Rotor 28 operates in conjunction with screw mechanism 29 which when actuated upon moves up or down in order to cause the displacement of arm 30. The pivot point 31 is located at a quarter of the length of the arm 30 so that small displacements by the linear actuator formed by rotor 28 and screw mechanism 29 result in large displacements of arm 30 at its free extremity 32. This particular arrangement is advantageous because it economises the required displacement of the linear actuator and therefore reduces its overall power consumption. This is a particularly important consideration when this linear actuator is powered by DC current as envisaged in one particularly advantageous aspect of this invention.

In this embodiment, the arm is adapted to slidably engage with the linear actuator and it is also envisaged that the screw mechanism comprises a retaining means (not illustrated in the drawing) in order to prevent the arm from pivoting under gravity. The cross section of the arm is also an important consideration in this embodiment and the applicant considers that an I-section is particularly suited to the particular loading conditions of this system.

The illustration of FIG. 2 presents the door security system in its open configuration where it allows the door leaf 11 to open freely. From this configuration, the rotor 28 would drive screw mechanism 29 in the upward direction thus causing the arm to pivot around point 31 in the clockwise direction until arm 30 reaches its blocking position.

In its blocking position, the load would be primarily transmitted to the chassis via the pivot point 31 and to the wall or other load bearing structure via the screw attachment means, two of which are illustrated at 24 and 25.

This door security system comprises no component on the door itself and therefore distinguishes itself fundamentally from some prior art systems that do.

The invention also envisages the incorporation of cushioning means 33 on the free extremity 32 of arm 30 to prevent any damage (although unlikely) to the door's face which would result from the repeated operation of the system over time.

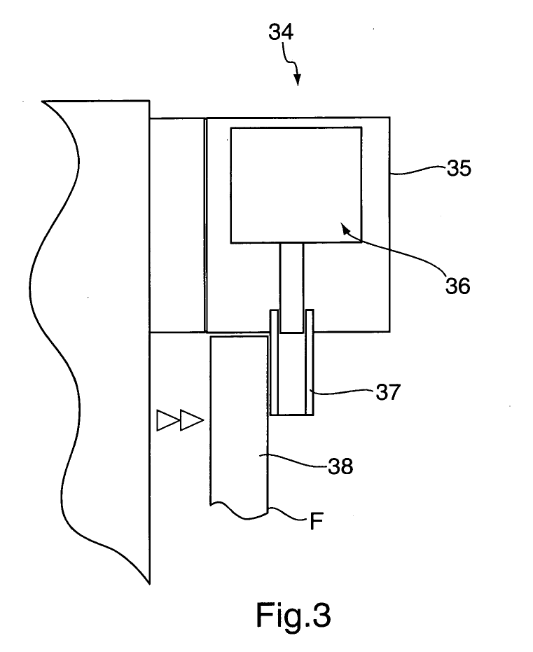

FIG. 3 presents a further door security system generally referenced at 34. As in the previous embodiments, it comprises a chassis 35 designed to enclose a linear actuating means 36. This linear actuating means drives an arm 37 in such a way that it extends and retracts from the chassis along a line of action which is essentially parallel to the face F of the door leaf 38. The illustration of FIG. 3 shows the arm 37 in its blocking mode fully extended out of its chassis. In this configuration, door leaf 38 is held against arm 37 in a partially opened position sufficient for audible communication from inside to outside to take place and also permitting the passage of small objects such as a parcel, while at the same time preventing the entry of any person from the outside to the inside of the door. When the door is closed (not illustrated in the drawings) the line of action of the arm is essentially parallel face of the door leaf whilst being spaced there from.

The invention also envisages that notices may be affixed to the outside face of the door leaf and adapted to display, for example the following information comprising:

A warning text (‘you are being filmed by CCTV’)

Device or logo indicating in generally recognised terms a connection with authority, for example, a Police dogs profile or a Policeman figure

A specific text (‘this door is alarmed and is connected to the nearest area Police Station electronically’)

It is also envisaged in this invention that self adhesive, self illuminated, or other notices of this kind are being incorporated on the door leaf itself or nearby to be readily viewed by any visitor. It is thought that these self adhesives or the like could be supplied by local Police authorities (particularly for the Elderly) for use in conjunction with the invention or alone in their own right.

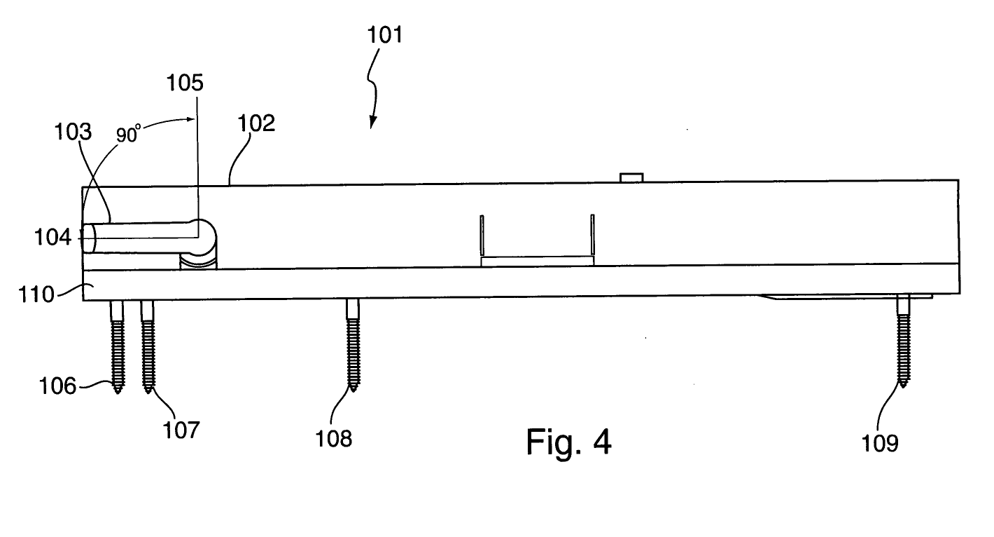

FIG. 4 shows a security system generally referenced 101 which is particularly suited for being fitted neighbouring a closure leaf such as a door or window. The security system incorporates a housing 102 for the electronic and mechanical components. The housing may be made of steel or any other similarly appropriate material which resists bending. Protruding from housing 102 there is provided an arm 103 which is rotatable as indicated by the figure between position 104 and 105. In position 104, the arm is in its inoperative position in which it does not block the opening and closing of the closure leaf. In position 105, the arm is in its operative position in which it allows the door to be opened to a pre-determined partially opened degree. A rotor located within the housing drives the motion from position 104 to position 105 and from position 105 to position 104. A number of bolts such as bolts 106, 107, 108 and 109 are provided at regular intervals along the base portion 110 in order to secure the security system to a wall portion in the vicinity of a door frame.

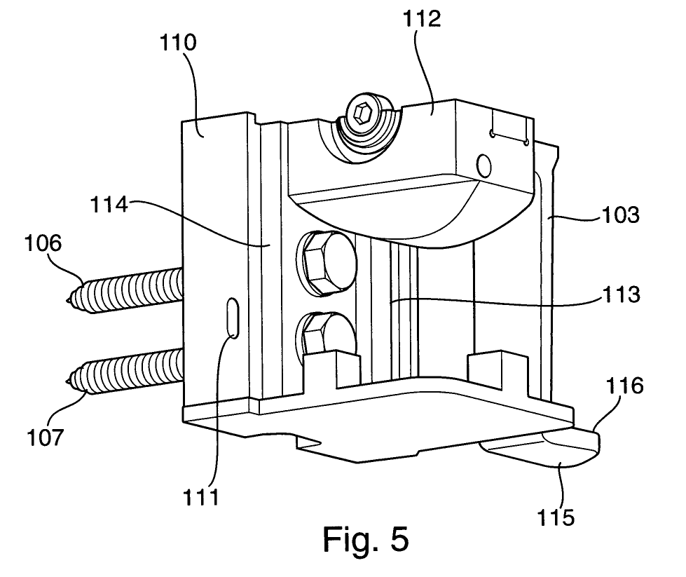

FIG. 5 shows bolts 106 and 107 in greater detail as well as the inside portion of the end of a security system. The cover of the housing clips into recess 111 provided on base 110. A gear housing 112 transmits the rotation of the shaft of a rotor to the arm 103. The gear housing 112 is shaped and configured to attach to rails 113 and 114 provided in the base portion 110 of the security system. This allows the arm to be placed at various locations along the base in order to be able to suit a variety of doors and entrances to buildings for example. The arm 103 is shown as substantially L shaped with convex inner and outer faces 115 and 116.

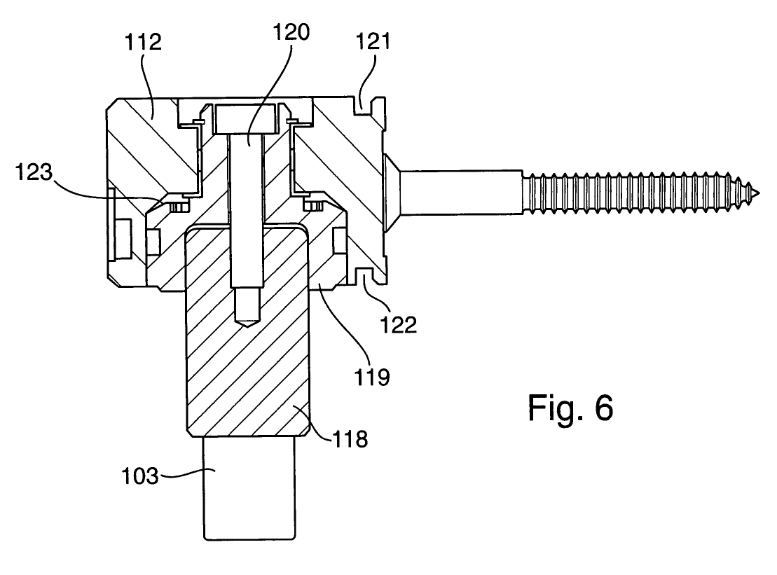

FIG. 6 shows arm 103 and gear housing 112 in greater detail. Arm 103 is connected to gear housing 112 via an integral mounting block 118 to the moveable portion of the gear 119. The moveable portion 119 is secured to mounting block 118 via a screw 120. Gear housing 112 incorporates two troughs 121 and 122 which correspond to rails 113 and 114 located on the base of the security system. Appropriately sized teeth (not shown) of the rotor shaft engage appropriately sized teeth 123 of the moveable portion.

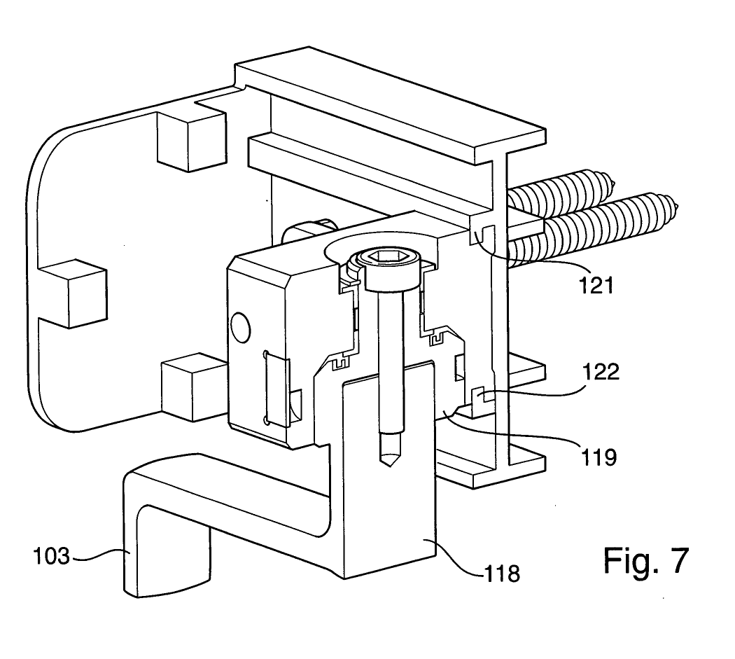

FIG. 7 shows the previously described components of FIG. 6 in greater detail in this embodiment mounting block 118 and arm 103 are integrally formed.

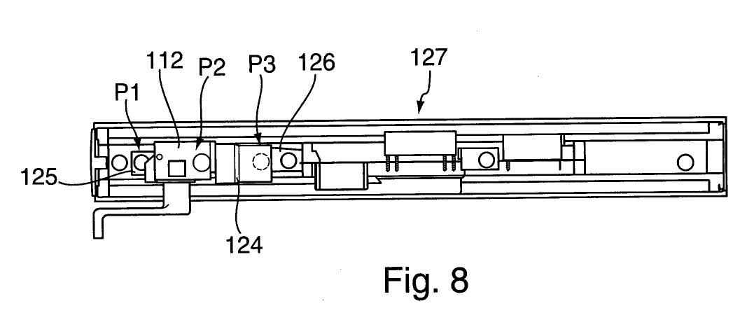

FIG. 8 shows the rotor 124 engaging the gear housing 112. The combination of gear housing and rotor are secured not only via the troughs and rails described previously but also via extension portions 125 and 126 which allow bolts to be located. This configuration allows the combination of gear housing and rotor to be secured independently from the rest of the housing. Other components of the security system are shown such as the necessary control circuitry generally referenced 127.

In this embodiment, a number of holes through the base of the security system are envisaged whereby the combination of gear housing and rotor can be placed and secured to the base at a variety of positions P₁ P₂ and P₃.

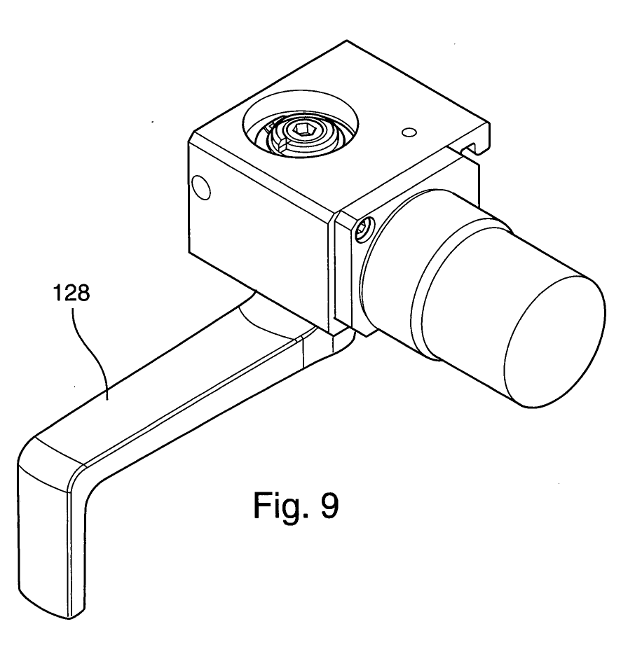

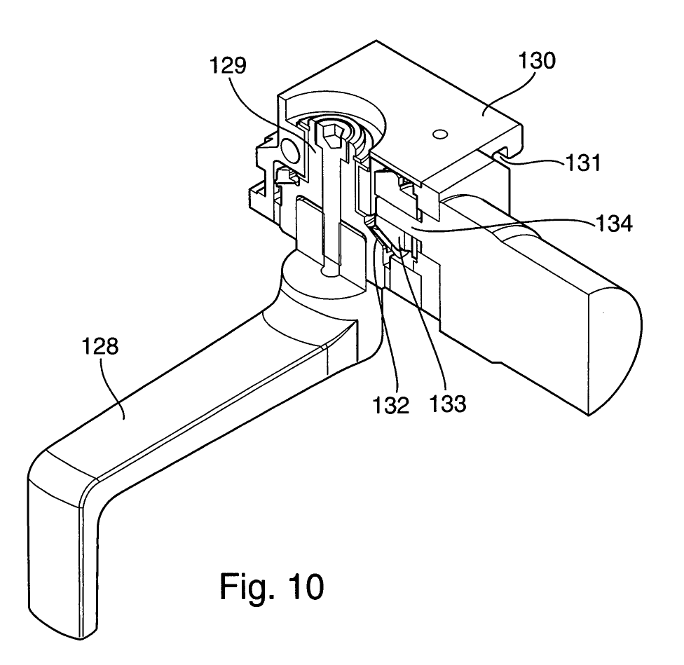

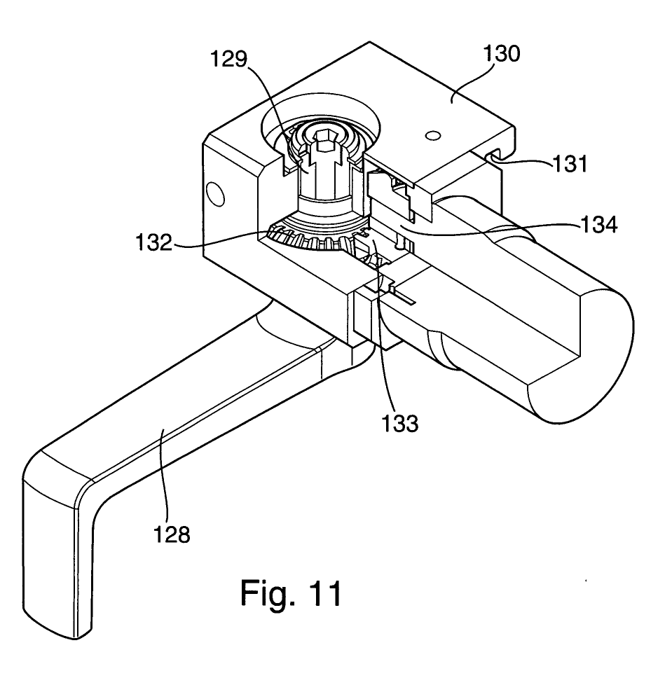

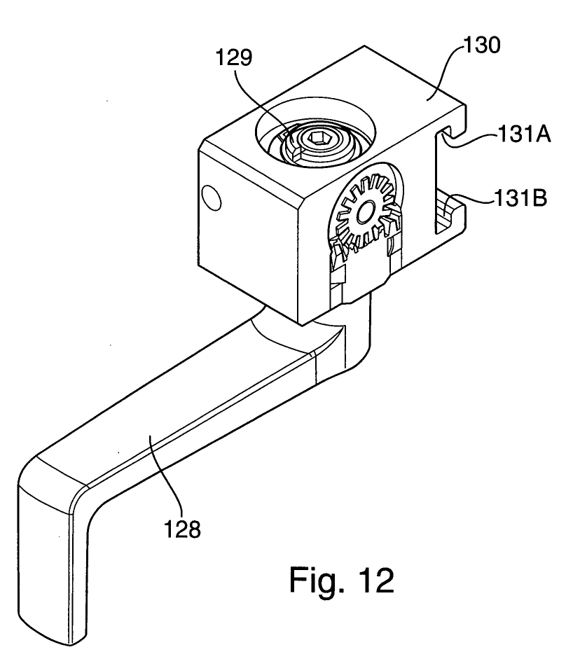

FIGS. 9, 10, 11, and 12 show an arm 128 attached via shaft 129 to a housing 130 which may be secured via trough 131A onto a corresponding rail of a chassis. A further trough 131B (FIG. 12) located on the opposite side of the housing 130 is provided for securing the housing to the rail or guide (not shown). Shaft 129 incorporates a tapered portion 132 with gear teeth for engagement with corresponding gear teeth provided on a further shaft 133 with a tapered portion. Shaft 133 engages with the rotor shaft 134. The gears allow the axes of rotation of the shafts to be at 90 degrees from one another in order to improve the compactness of the system.

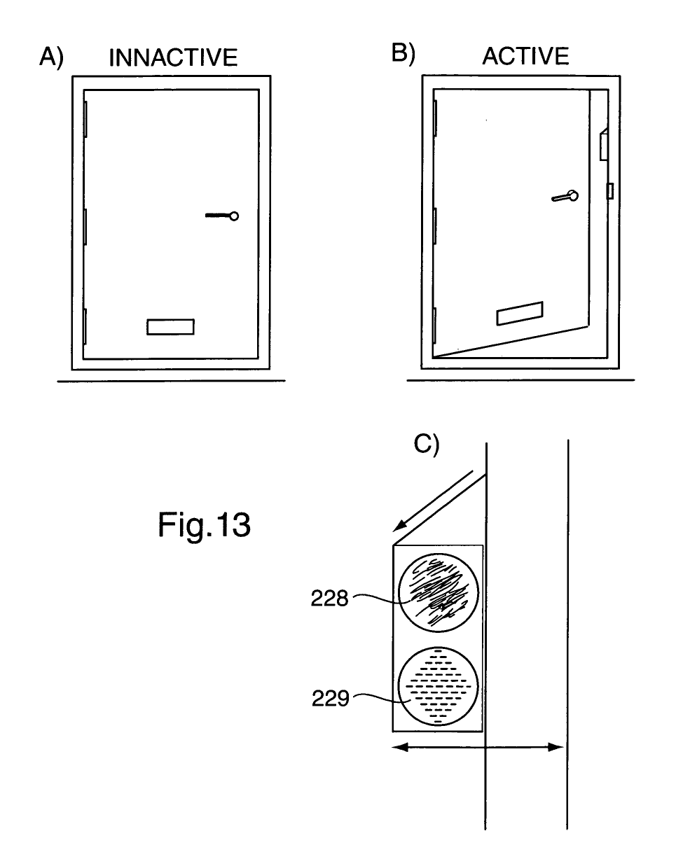

FIG. 13A shows a door in its inactive position. FIG. 13B shows a door which has been marginally opened and in which a security component pops out of the frame into sight. The security component may incorporate a battery to allow it to be self sufficient. Alternatively, it may be wired through the frame of the door. In this embodiment it comprises a camera or a mini-camera 228 located next to a sprayer 229.

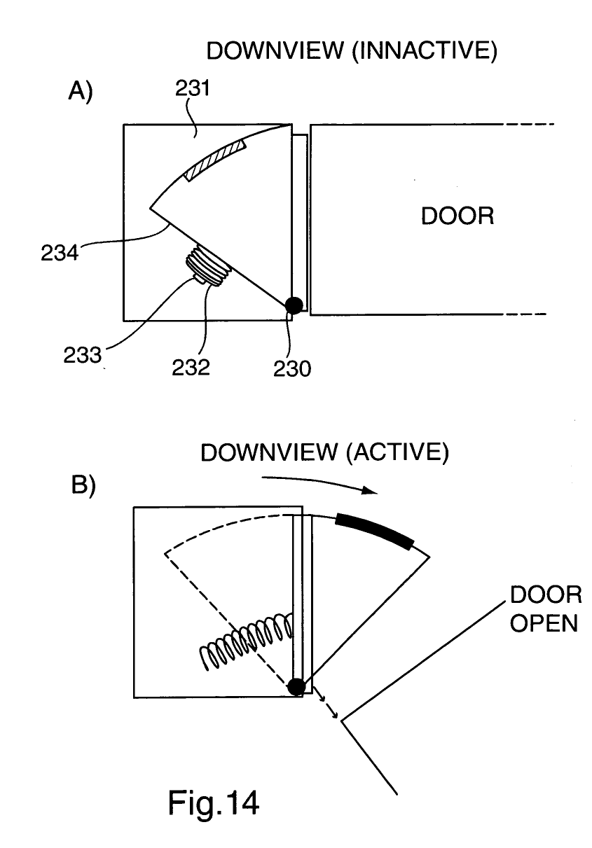

As can be seen in FIG. 14, the security component is substantially triangular in cross-section. The component is hinged by hinge 230 and located in a hollow portion 231 of a door frame. A spring 232 is located between an abutment 233 and face 234 of the security component. As the door is opened, the compression in the spring causes the component to exit from the door frame in order to expose the camera and sprayer as shown in FIG. 14B. As the door is shut the door engages the narrow portion of the triangle and forces the security component back into the hollow space provided in the door frame. The electronics of the system are set to cause the security component to be active only when it is in its popped out position in which the camera records pictures and/or videos of the scene in front of the front door. If an unauthorized access attempt is made, a sensor is activated and chemical produce is fired out of the sprayer.

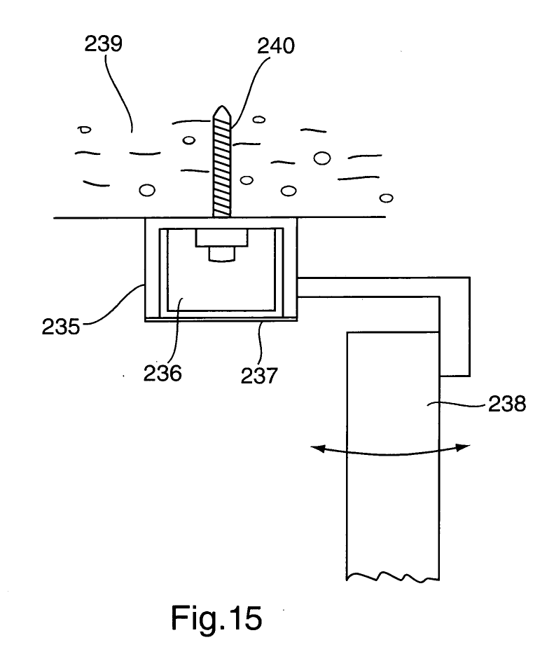

FIG. 15 shows a U shaped door frame 235 and a security device 236 located within the door frame. The frame is sealed in a conventional manner with a plate 237 extending around the periphery of the door. The security device 236 incorporates an arm which may be displaced into and out of a pre-determined door blocking position in order to prevent door 38 from being opened beyond this blocked position. In this embodiment the security system is also protected by the door frame itself. Both the door frame and the security system may be simultaneously secured to a neighbouring wall 239 via a bolt 240.

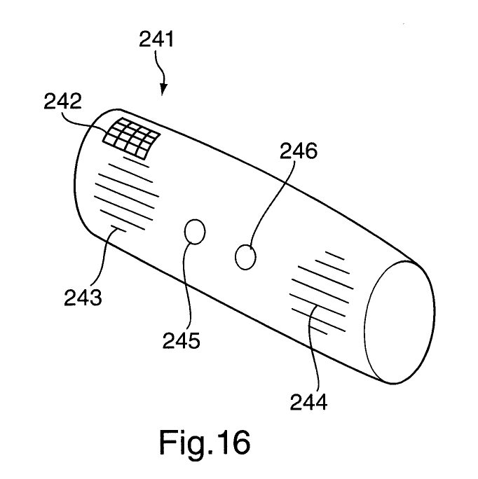

FIG. 16 shows a portable security unit 241 with a touch pad 244 activating and deactivating the unit. It incorporates a number of loud speakers 243 and 244 which can have the dual function of emitting sound and/or an alarm signal. The sound may be produced by any appropriate audio device such as a radio receiver. The security unit incorporates a motion sensor 245 which may be a mercury/impact switch or a sonic bubble which may be aimed, aligned or placed towards the hotel, apartment, caravan, tent, entrance and may be set by the control pad by entering a 4-digit code which would set a pre-determined time period before the system would be armed. The time delay may be for example 10 to 20 seconds. In addition to the motion sensor the unit may incorporate a smoke/carbon monoxide detector 246 to sound the alarm if a pre-determined level of smoke and/or carbon monoxide is breached.

Instead or as well as the motion sensor a camera such as a mini camera may be fitted. It is preferred that the mini camera has a night vision capability. The camera would also preferably be operated by a motion sensor which could be aimed at a door. A small screen on top of the unit may be employed for alignment.

When activated by motion, the camera will record for a length of time. The audible warning may be in the form, of initially the words “alarm activated” which would provide the potential intruder with sufficient time to think again and leave. The unit would preferably incorporate translation software so that any statement produced by the alarm system could be in the language of the country being visited at the time.

If movement continues or a shock sensor is triggered, the alarm would be set to sound. The battery contained within the unit would allow the alarm to sound until it is de-activated by entering a four-digit code.

The system may also incorporate text-pictures/video messaging facilities in order to transmit a message to an occupier/user that the alarm has been activated in order to allow him/her to take appropriate action.

Furthermore, the system may transmit a picture and video so that if the person identified by the camera of the unit is no intruder then the unit may be controlled remotely to switch off. A wireless transmitting and receiving facility would therefore be incorporated within the unit.

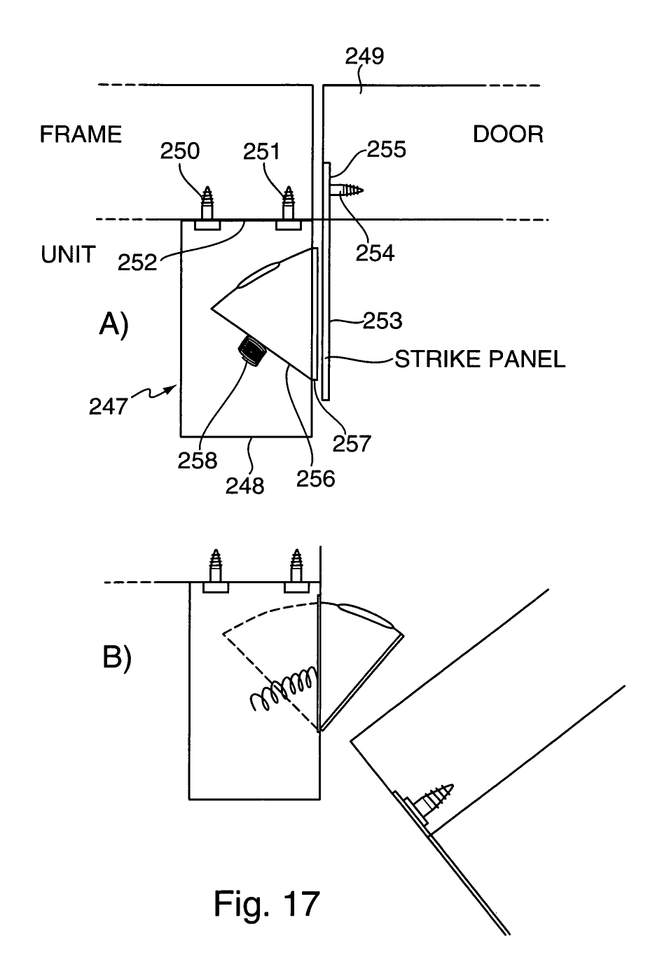

FIG. 17 show a stand-alone security unit 247 which incorporates a housing 248 which may be secured to an existing door frame or a replacement door frame or to the wall adjacent to door leaf 249 by employing one or more screws such as screws 250 and 251. Appropriate projecting portions 252 are provided with a number of recesses to accommodate these screws. A strike panel 253 in the form of a plate which is attached to door 249 via one or more screws 254 which pass through appropriately sized holes 255.

The mechanism of this stand-alone security unit is similar to the mechanism described with regard to FIGS. 13 and 14. Within housing 248 there is provided a security component 256 which is hinged at one corner 257 and biased to tend to protrude from an opening in the housing by a spring 258. The spring 258 causes the security component 256 to pop out of housing 248 when the door and its strike panel are removed when it is opened. This configuration is shown in FIG. 210b. When the security component pops out it reveals either a camera or a sprayer or both. In this stand-alone version the housing 248 may incorporate batteries for driving the function of the camera and sprayer.

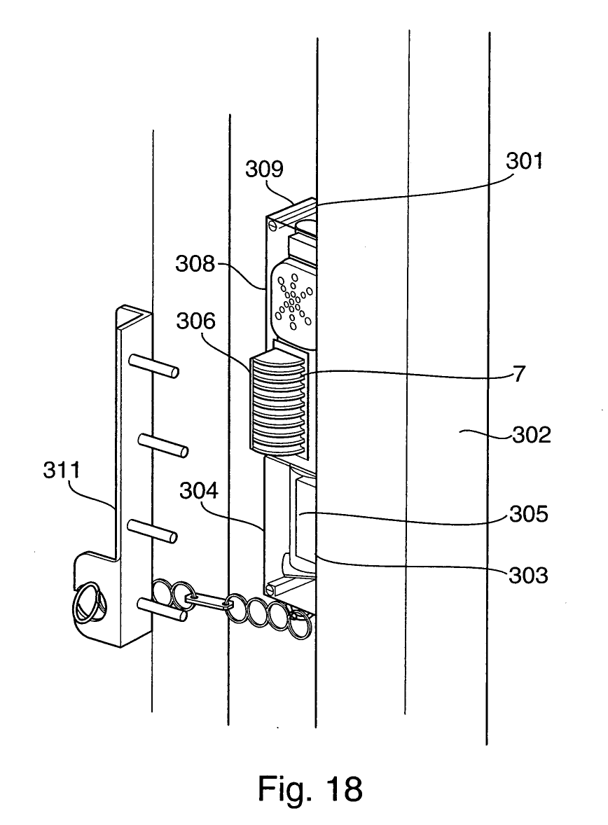

FIG. 18 shows a security system when fitted to a closure leaf such as a door or window. Portion 301 of the security system is secured to the doorframe 302 by a plate 303 incorporating a number of apertures through which a number of releasable attachment means such as screws are provided. Once this plate is secured to the doorframe, housing 304 is secured to the plate. Inside housing 304, a canister 305 is provided which may incorporate pressurised chemicals which may be selected from the following group: tear gas, liquids with uniquely identifiable DNA strands and/or dyes. A pop-out unit 306 incorporates a wedge shaped portion with a plurality of closely contiguous apertures such as aperture 307. When pressurised fluid is allowed to flow through these apertures, a spray is achieved. The pop-out unit is caused to be in the position shown by a bias. Circuitry is provided within the housing in order to cause the security system to be armed when the pop-out unit is in its popped-out position.

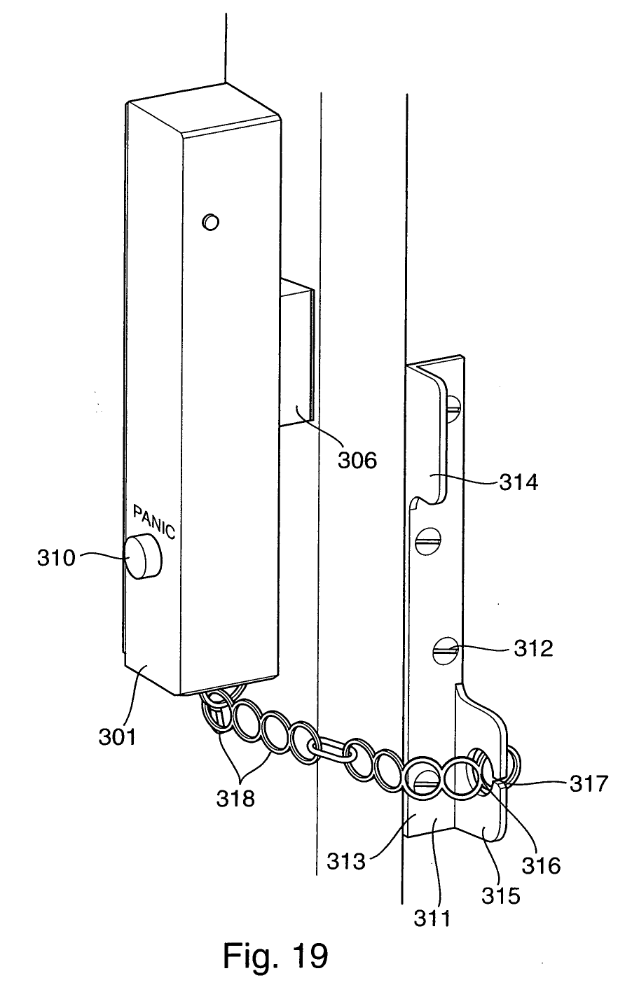

The housing also incorporates a plurality of apertures in its front face such as aperture 308. These apertures extend in a number of lines in radial directions from a centre point. In close proximity to said apertures and within the housing, there is provided an alarm generator such as a sounder 9 which may cause a panic alarm to sound. The panic alarm may be triggered by an operator pressing a panic button 310 as shown in FIG. 19 or simply because the security system detects an abnormal pressure being exerted on the door so that an alarm is sounded. The alarm may take several forms. It may for example be a personalised recording or a noise.

FIG. 19 shows the pop-out unit in its popped-out position as well. FIG. 19 shows a portion 311 which is secured to the door leaf itself by employing a number of screws such as screw 312. Portion 311 incorporates a flat base portion 313 with two projections 314 and 315. Projection 314 acts as a strike panel against which pop-out unit 306 engages when the door leaf is closed. The strike panel ensures that the pop-out unit remains inside the security system's housing when the door leaf is shut. Projection 315 incorporates an aperture 16 with a side opening 317 through which a chain may be threaded. A chain 318 is provided between portion 311 which is secured to the door leaf and portion 301 which is secured to the door leaf frame. The door chain acts as a trigger for the security system. If a pressure is applied to the door leaf which exceeds a predetermined threshold, then either the alarm generator 309 sounds or the pop-out unit sprays. The invention also envisages replacing the sprayer by a camera. Alternatively, the unit may also incorporate both a sprayer and a camera located in the same pop-out unit or located in two separate pop-out units.

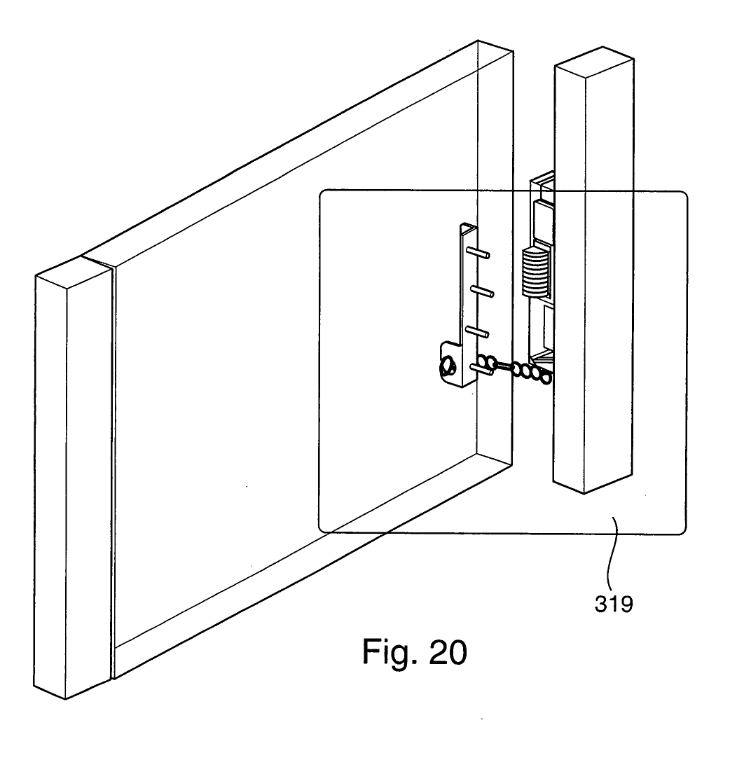

FIG. 20 shows the same security unit embodiment as shown in FIGS. 18 and 19 with the addition of a potential spraying zone 319.

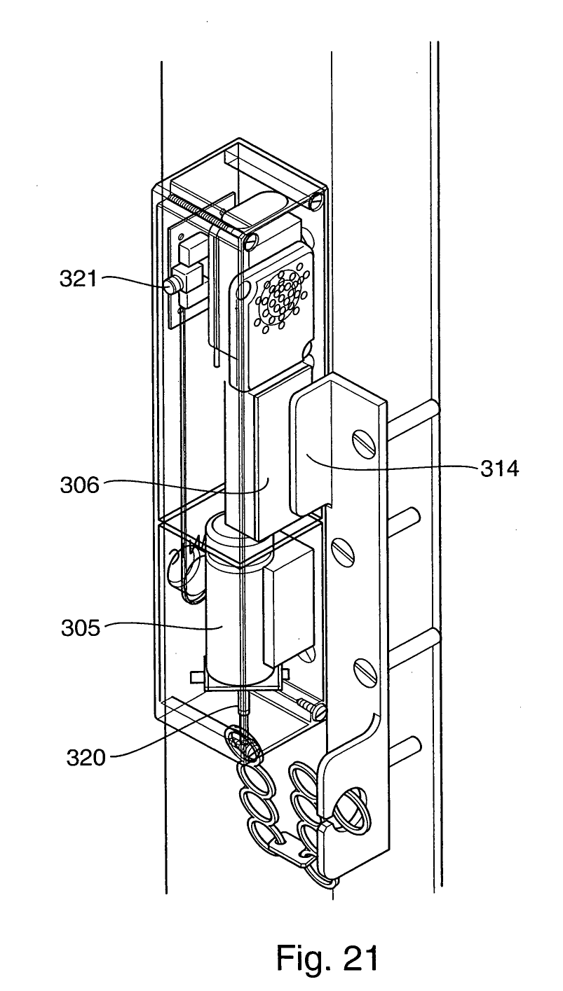

FIG. 21 shows the pop-out unit 306 in its retracted position as the strike plate 314 causes it to retain within the cavity provided within the housing. Canister 305 incorporates a button or valve 320 which when drawn downwards causes pressurised fluids to be channeled to the sprayer. A safety mechanism may be provided so that when the pop-out unit 306 is in its retracted position no pressurised fluid can exit from the unit. A battery 321 may be provided to cause the sounder to sound an alarm when either the panic button is pressed or an excessive pressure is applied on the door leaf.

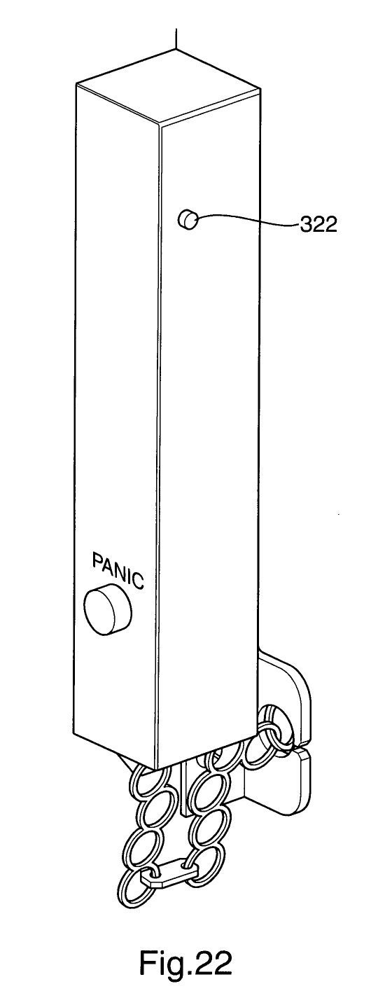

FIG. 22 shows a further view of the door leaf in its closed position. An operational indicating means 322 in the form of a light emitting diode is also provided so that a user may check whether the system is armed.

The portion of the security system which is fixed to the door frame or to an adjacent structural portion may also be incorporated inside the door frame itself. In this configuration, the edge of the door itself would act as the strike panel and the triggering of the mechanism would be achieved by an appropriate means for sensing forced entry. This appropriate means may be for example, incorporated into a chainless door blocker.

1. A security system for constraining the degree to which a closure leaf such as a door may be opened of the type having an inoperative position in which it does not block the opening and closing of the closure leaf, and an operative position in which it does so block the opening of the closure leaf beyond a predetermined constrained degree; and means for selectively activating said system for effecting movement between said inoperative and said operative position, the improvement comprising:
an electric actuator comprising a motor having a rotatable output shaft; an arm operating in response to movement of said output shaft of said actuator, whereby said actuator drives said arm both into and out of said operative position; and
at least a portion of said arm when in said operative position is moved into a position where said arm acts as a barrier to said door leaf being opened beyond a predetermined degree.

2. A system according to claim 1, further comprising a gear mechanism located between said electric motor and said arm.

3. A system according to claim 1, further comprising a chassis, means for mounting said actuator on said chassis, and means for mounting said chassis on a structure surrounding the closure leaf.

4. A system according to claim 3, further comprising a closure leaf frame and said chassis is mounted in said frame.

5. A system according to claim 1, further comprising a unit which pops into sight when the closure leaf is open and which returns to a retracted position as the leaf is closed, wherein said unit incorporates a powered security component which is switched on when the unit is in its popped out position.

6. A system according to claim 5, wherein said security component is a camera.

7. A system according to claim 5, wherein said security component is a sprayer.

8. A security system for constraining the opening of a closure leaf such as a door beyond a pre-determined partially opened degree comprising a chassis; means for mounting said chassis, in use, adjacent an opening edge of said closure leaf; an arm which is displaceable from an inoperative position in which it does not block the opening and closing of the closure leaf, into and out of an operative position beyond said chassis in which it does so block the opening of the closure leaf beyond said pre-determined partially opened degree; wherein means for mounting said chassis incorporate a plurality of predetermined positions for securing said chassis.

9. A system according to claim 8, wherein said means for mounting incorporates one or more rails and said chassis is mounted on said rails in order to be placed in a plurality of predetermined positions.

10. A security system for a closure leaf such as a door comprising a unit which pops into sight when the closure leaf is open and which returns to a retracted position as the leaf is closed, wherein said unit incorporates a powered security component which is switched on when the unit is in its popped out position.

11. A security system according to claim 10, wherein said security component is a camera.

12. A security system according to claim 10, wherein said security component is a sprayer.

13. A security system according to claim 10, wherein said unit is located in a cavity of a frame, is hinged on said frame and a bias is provided to cause said unit to pop out of the frame when the closure leaf is open.

14. A security system according to claim 11, wherein said camera operates in conjunction with a wireless transmitter to transmit signals representative of images to a location remote from said unit.

15. A security system according to claim 12, wherein said powered security component operates in conjunction with an arm which prevents the door from opening beyond a predetermined partially opened degree and is activated when excessive pressure is applied on said arm.

16. A security system for a closure leaf such as a door comprising a unit which pops into sight when the closure leaf is open and which returns to a retracted position as the leaf is closed, characterised in that said unit incorporates a powered security component, which is switched on when the unit is in its popped out position and a linkage member extending between a portion of said security system secured adjacent to said closure leaf and a portion of said security system secured on said closure leaf; wherein when pressure is exerted on said closure leaf beyond a predetermined level a security component is actuated.

17. A security system according to claim 18, wherein said security component incorporates a sprayer.

18. A security system according to claim 18, wherein said security component incorporates a camera.
